(19) United States
(12) Patent Application Publication
(10) Pub. No.: US 2025/0019282 A1
(43) Pub. Date: Jan. 16, 2025

(54) Method for Reverse Osmosis

(71) Applicant: LOCUS SOLUTIONS IPCO, LLC, SOLON, OH (US)

(72) Inventor: Sean FARMER, Ft. Lauderdale, FL (US)

(21) Appl. No.: 18/764,498

(22) Filed: Jul. 5, 2024

Related U.S. Application Data
(60) Provisional application No. 63/512,464, filed on Jul. 7, 2023.

(51) Int. Cl. C02F 3/34

(52) U.S. Cl. CPC C02F 3/347; C02F 2305/04

(57) ABSTRACT

The subject invention provides safe, environmentally friendly compositions and efficient methods for reverse osmosis. More specifically, the subject invention provides compositions derived from microorganisms for reverse osmosis, which can be used for increasing the rate of reverse osmosis, the quality of the purified liquid resulting from reverse osmosis, the filtration efficiency of the semi-permeable reverse osmosis membrane, or any combination thereof.

### CROSS REFERENCE TO RELATED APPLICATION

This application claims priority to U.S. Provisional Patent Application No. 63/512,464, filed Jul. 7, 2023, which is incorporated herein by reference in its entirety.

### BACKGROUND OF THE INVENTION

Reverse osmosis is the process by which a solvent passes through a porous, semi-permeable membrane in the opposite direction of osmosis. Osmosis is a naturally occurring process in nature that involves the movement of a solution through a selectively-permeable membrane from a region of lower solute concentration to a region of higher solute concentration. Examples of osmosis are found in human cells, plant roots, fruits, and vegetables. A semi-permeable membrane is a membrane that allows some atoms or molecules to pass through it, but not others.

Reverse osmosis is a water purification process that uses the permeable membrane to separate impurities from the water. While osmosis occurs without energy, reverse osmosis requires energy. The process of reverse osmosis can be used to filter out unwanted molecules, such as, for example, contaminants and sediments from drinking water.

Reverse osmosis uses a high-pressure pump to increase the pressure on a contaminated liquid to force the contaminated liquid across a semi-permeable membrane. The more concentrated the contaminated water, the more pressure is required to overcome the osmotic pressure.

Reverse osmosis can remove about 99% of various impurities from water, including, for example, dissolved salts, particles, colloids, organic compounds, bacteria, and pyrogens. The reverse osmosis membrane rejects contaminants based on size and charge. Any contaminant that has a molecular weight greater than about 200 grams per mole is likely to be rejected by a functioning reverse osmosis system. Reverse osmosis is very effective in treating brackish, surface, and ground water for both large and small flow applications. Some examples of industries that use reverse osmosis to treat water include, for example, pharmaceutical, boiler feed water, food and beverage, metal finishing, and semiconductor manufacturing.

Reverse osmosis relies on a variety of factors, including, but not limited to, feed pressure, permeate pressure, concentrate pressure, feed conductivity, permeate conductivity, feed flow, permeate flow, and temperature.

Reverse osmosis is generally one stage or two stages and one pass or two passes. In a one stage reverse osmosis system, the contaminated water enters the system as one stream and exits the reverse osmosis system as either concentrate (i.e., water that does not pass through the semi-permeable membrane of the reverse osmosis system) or permeate water (i.e., water that passes through the semi-permeable membrane of the reverse osmosis system). In a two-stage system, the concentrate from a first stage of passing water through a semi-permeable membrane becomes the feed water to the second stage. The permeate water is collected from the first stage and is combined with permeate water from the second stage. Additional stages increase the recovery from the system.

In a reverse osmosis system, an array describes the physical arrangement of the pressure vessels in a 2-stage system. Pressure vessels contain reverse osmosis membranes (usually from about 1 to about 6 reverse osmosis membranes). The reject water of each stage becomes the feed stream for the next successive stage.

While reverse osmosis water filtration effectively purifies water, it has some disadvantages. The traditional reverse osmosis systems can waste between about 3 to about 20 times as much water as they produce. Reverse osmosis also removes health-promoting minerals from the water, including calcium, magnesium, potassium, and other bicarbonates. Reverse osmosis is also expensive to install and maintain and requires professional maintenance to ensure safety and effectiveness.

A chemical surfactant can be used during the reverse osmosis process, but they have disadvantages, including harming aquatic life, polluting water, and endangering human health. Therefore, a more efficient and less harmful method of reverse osmosis is needed.

### BRIEF SUMMARY OF THE INVENTION

The subject invention generally relates to reverse osmosis filtration compositions and methods of using these compositions. More specifically, the subject invention comprises the contacting of a composition comprising a biosurfactant to contaminated water and/or to a semi-permeable membrane used in reverse osmosis. In certain embodiments, existing reverse osmosis methods can incorporate the subject compositions and methods.

Advantageously, the compositions and methods of the subject invention increase the efficiency of reverse osmosis and can decrease chemical usage, including chemical surfactant usage, which can be required for reverse osmosis.

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water; chemical surfactants, including, for example, ionic surfactants or nonionic surfactants; flocculants; clarifying agents; filtration aids; or any combination thereof.

In certain embodiments, the subject compositions can be applied to the semipermeable membrane in reverse osmosis. This membrane can include, for example, microfiltration membranes, ultrafiltration membranes, nanofiltration membranes, or any combination thereof. In certain embodiments, the membranes are composed of three layers: a bottom layer made of, for example, unwoven polyester cloth, a middle layer made of, for example, polysulfone or polyethersulfone, and a top layer made of, for example, polyamide or polyetherimide.

In certain embodiments, the subject compositions and methods can be used to filter, for example, salt water into potable water.

In certain embodiments, the biosurfactant of the composition is utilized in crude form. The crude form can comprise, in addition to the biosurfactant, fermentation broth in which a biosurfactant-producing microorganism was cultivated, residual microbial cell material or live or inactive microbial cells, residual nutrients, and/or other microbial growth by-products.

In some embodiments, the biosurfactant is utilized after being extracted from a fermentation broth and, optionally, purified.

The biosurfactant according to the subject invention can be, for example, a glycolipid (e.g., sophorolipids, rhamnolipids, cellobiose lipids, mannosylerythritol lipids and trehalose lipids), lipopeptide (e.g., surfactin, iturin, fengycin, arthrofactin, and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically. In preferred embodiments, the SLP is a linear SLP or a derivatized linear SLP.

In certain embodiments, the method comprises introducing an aqueous solution containing impurities and a composition comprising a biosurfactant to the high-pressure side of a reverse osmosis membrane and pressurizing the aqueous solution on the high-pressure side to produce liquid on the low-pressure side substantially free of the impurities. In certain embodiments, the impurities can be concentrated on the high-pressure side of the reverse osmosis membrane. In certain embodiments, a composition comprising a biosurfactant can be contacted to the reverse osmosis membrane before the aqueous solution is applied to the reverse osmosis membrane. In certain embodiments, the concentrated impurities can be removed from the high-pressure side of the reverse osmosis membrane.

In certain embodiments, the subject invention provides a method for reverse osmosis, wherein the method comprises the following steps:
a) contacting a composition comprising a biosurfactant with a liquid containing an impurity; and
b) filtering the liquid through a membrane having a high-pressure side and a low-pressure side.

In certain embodiments, the subject invention provides a method for reverse osmosis, wherein the method comprises the following steps:
a) contacting a composition comprising a biosurfactant with a membrane filter; and
b) filtering a liquid containing an impurity through the membrane filter having a high-pressure side and a low-pressure side.

In certain embodiments, the removal of an impurity can be performed using a pressurized flow of a liquid to overcome the osmotic pressure of the liquid.

In some embodiments, the filtered impurity can be less than about 10 cm, about 75 mm, about 50 mm, about 25 mm, about 10 mm, about 5 mm, about 1 mm, about 100 μm, about 10 μm, about 1 μm, about 100 nm, about 10 nm, or about 1 nm in diameter in diameter.

In some embodiments, the method comprises contacting a composition comprising a biosurfactant and, optionally, other components, such as, for example, water, chemical surfactants, flocculants, clarifying agents, or filtration aids. In certain embodiments, the composition of the subject invention can be contacted to the liquid containing the impurity or the membrane for a period of time and/or until a distinct volume of the composition has been contacted to the liquid or membrane. The step can be repeated as many times as necessary to achieve a rate of purification or until a desired amount of impurities are removed from the liquid.

In certain embodiments, the composition according to the subject invention is effective due to enhancing and/or increasing the rate of purifying a liquid by accumulating the impurities on the high-pressure side of a membrane. For example, in some embodiments, a sophorolipid will form a micelle containing or linking the impurities, wherein the micelle is less than 500 μm, less than 100 μm, less than 10 μm, less than 1 μm, less than 100 nm, less than 50 nm, less than 25 nm, less than 15 nm or less than 10 nm in size.

In certain embodiments, the methods of the subject invention result in at least a 25% increase in the rate of the purification of a liquid when compared to a liquid that is purified without the use of the subject compositions, preferably at least a 50% increase, after one treatment. In certain embodiments, the contaminated water can be treated multiple times to further increase the rate of purification.

In certain embodiments, insoluble and/or soluble inorganic salts can be removed from water using the subject compositions and methods. In certain embodiments, 90% to 99% of the water can be recovered.

In certain embodiments, the subject compositions and methods can reduce the formation of scalants or other types of blockages in the reverse osmosis membrane.

In certain embodiments, a cross flow microfiltration membrane, ultrafiltration membrane or a dead-end cartridge filter, preferably in the microfiltration range, can be used to separate impurities from the liquid.

Advantageously, in certain embodiments, the composition according to the subject invention can be effective at removing impurities from an aqueous solution, particularly water. Furthermore, the methods of the subject invention do not require complicated equipment or high energy consumption, and production of the composition can be performed on site, for example, at a wastewater treatment facility or a desalination plant.

### DETAILED DESCRIPTION

The subject invention relates generally to the filtering of contaminants out of a liquid using reverse osmosis. More specifically, the subject invention provides effective and environmentally friendly methods to perform reverse osmosis by contacting biosurfactants to a semi-permeable membrane and/or applying biosurfactants to a contaminated liquid. Accordingly, the subject invention is useful for improving the efficiency and efficacy of methods of reverse osmosis.

Advantageously, the use of biosurfactants to remove contaminants from water via reverse osmosis is more efficient, and removes a greater amount of impurities, when compared to a reverse osmosis process that does not use the subject compositions. In certain embodiments, reverse osmosis can remove sodium, chloride, copper, chromium, and lead salts from water. In certain embodiments, the compositions of the subject invention can inhibit the formation of scalants on the reverse osmosis membrane.

### Selected Definitions

As used herein, “applying” a composition or product refers to contacting it with a target or site such that the composition or product can influence that target or site. The effect can be due to, for example, microbial growth and/or the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally occurring state. A purified or isolated polypeptide is free of the amino acids or sequences that flank it in its naturally occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to form pores and destabilize biological membranes also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, SLP-salt derivatives (e.g., a sodium salt of a linear SLP), and other, including those that are and/or are not described within in this disclosure.

In some embodiments, the SLP molecules according to the subject invention are represented by General Formula (1) and/or General Formula (2) and are obtained as a collection of multiple types of structural homologues:

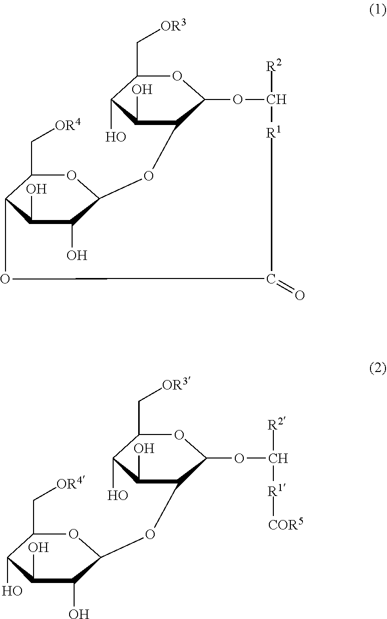

where R¹ and R^{1′} independently represent saturated hydrocarbon chains or single or multiple, in particular single, unsaturated hydrocarbon chains having 8 to 20 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃. R⁵ is typically, but not limited to, —OH.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in abroad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

As used herein, the term “substantially free” in the context of removing impurities from an aqueous solution, such as, for example, salt, refers to removing at least 60%, 65%, 70%, 75%, 80%, 85%, 90%, 95%, 96%, 97%, 98%, 99%, 99.9%, 99.99%, or 99.999% of the impurities in the aqueous solution.

As used herein, the term “permeate water” refers to the treated water resulting from reverse osmosis that is demineralized and/or deionized.

As used herein, the term “reject stream” refers to water that does not pass through the semi-permeable membrane during reverse osmosis.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Reverse Osmosis Compositions

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water, chemical surfactants, clarifying agents, flocculants, filtration aids, antiscalants, preservatives, chlorine removers, membrane cleaners, pH boosters, biocides, or any combination thereof.

In certain embodiments, the chemical surfactant is, for example, a detergent, wetting agent, emulsifier, foaming agent, and/or dispersant. In certain embodiments, the chemical surfactants, include, for example, ionic and/or nonionic surfactants. In certain embodiments, the ionic surfactants can be, for example, fatty alcohol sulfates (e.g., sodium dodecyl sulfate or ammonium dodecyl sulfate); fatty alcohol ether sulfates; alkyl sulfoacetates; fatty alcohol phosphoric acid esters; fatty alcohol ether phosphates; alcohol phosphoric acid esters, including, for example, triisobutyl phosphate, monoalkyl or dialkyl esters of sulfosuccinic acid (e.g., dioctyl sodium sulfosuccinate, alkyl sulfonates, alkylbenzenesulfonates, including, for example, dodecylbenzenesulfonic acid); and nonionic surfactants, including, for example, fatty alcohol ethoxylates (e.g., alkylphenol ethoxylates, polyoxyethylene fatty acid esters, polypropylene glycol ethoxylates, fatty acid mono- and diglycerides, fatty acid glycol partial esters, sorbitan fatty acid esters, or polyoxyethylene sorbitan fatty acid esters). In certain embodiments, the chemical surfactant is Tween 80 (Polysorbate 80).

In certain embodiments, the clarifying agent is, for example, activated carbon, bentonite, casein and caseinates, diatomaceous earth, egg albumen, gelatin, isinglass (a type of gelatin obtained from fish), kieselsol (negatively charged fining made from silicon dioxide), polyvinylpyrrolidone (PVP), sparkolloid, or any combination thereof.

In certain embodiments, the flocculant is, for example, aluminum sulfate, aluminum chloride, sodium aluminate, aluminum chlorohydrate, polyaluminum chloride, or any combination thereof.

In certain embodiments, the filtration aid is, for example, diatomaceous earth, expanded perlite, cellulose, fly ash, carbon, or any combination thereof.

In certain embodiments, the antiscalant is, for example, sodium hexametaphosphate, calcium carbonate, calcium sulfate, strontium sulfate, barium sulfate, calcium phosphate, calcium fluoride, a polyacrylic acid, a carboxylic acid, a polymaleic acid, an organophosphate, a polyphosphate, a phosphonate, an anionic polymer, or any combination thereof.

In certain embodiments, the biocide is, for example, bleach (sodium hypochlorite), chlorinated isocyanurate (trichloro-s-triazinetrione), chlorine dioxide, DDAC QUAT (1-Decanaminium, N-decyl-N, N-dimethyl chloride), or any combination thereof.

In certain embodiments, the preservative is, for example, sodium metabisulphite (SMBS), DBNPA (2,2-dibromo-3nitrilopropionamide), CMIT (5-chloro-2-methyl-4-isothiazolin-3-one), MIT (2-methyl-4-isothiazolin-3-one), OIT (2-octyl-2H-isothiazol-3-one), Preservol TM L (PWT, Vista, CA), sodium benzoate, citric acid, potassium sorbate, phenoxyethanol, benzoic acid, sorbic acid, butylated hydroxytoluene, paraben, sodium nitrite, methylparaben, formaldehyde, butylated hydroxyanisole, sulfites, propionic acid, benzyl acid, sugar, nisin, acetic acid, vinegar, propyl gallate, tert-Butylhydroquinone, nitrite, lactic acid, or any combination thereof.

In certain embodiments, the chlorine remover can be chemical or natural. In certain embodiments, the chemical chlorine remover is, for example, potassium metabisulfite, sodium metabisulfite, sodium ascorbate, or any combination thereof. In certain embodiments, the natural chlorine remove is, for example, Vitamin C (ascorbic acid).

In certain embodiments, the membrane cleaner is applied to the reverse osmosis system to prevent clogging in the membrane. In certain embodiments, the membrane cleaner is, for example, hydrochloric acid, nitric acid, sodium hydroxide, sodium hypochlorite, sulfuric acid, citric acid, oxalic acid, and any combination thereof.

In certain embodiments, the pH booster in reverse osmosis can be a mixture of an alkalinity builder, an artificial sludge conditioner, and a softening agent. In other embodiments, the pH booster can contain mineral drops containing electrolytes; alkalis, such as, for example, sodium hydroxide; carbonates, such as, for example, sodium carbonate or bicarbonates, including, for example, sodium bicarbonate; or any combination thereof. In preferred embodiments, the pH booster can include, for example, sodium carbonate, ammonium hydroxide, calcium hydroxide, magnesium hydroxide, or any combination thereof.

Clarifying agents, flocculants, filtration aids, antiscalants, preservatives, chlorine removers, membrane cleaners, and pH boosters are all optional additives that can be used separately or in combination with each other in methods of reverse osmosis and/or compositions used in methods of reverse osmosis.

In some embodiments, semi-permeable membranes are used in reverse osmosis. In some embodiments, the semi-permeable membrane can be made of, for example, cellulose acetate, polysulfone coated with aromatic polyamides, thin-film composite polyamide, or any combination thereof. In certain embodiments, the semi-permeable membrane can have three layers: a bottom layer made of, for example, unwoven polyester cloth with a thickness of, for example, about 100 to about 200 μm, a middle layer comprising, for example, polysulfone or polyethersulfone with a thickness of, for example, about 30 to about 50 μm, and a top layer of, for example, polyamide or polyetherimide with a thickness of, for example, about 100 nm to about 200 nim. In certain embodiments, reverse osmosis membranes can be separated into three categories based on their membrane pore size for commercial use: microfiltration, ultrafiltration, and nanofiltration.

In certain embodiments, the reverse osmosis membrane can be an osmotic membrane that allows water through but not dissolved molecules, such as, for examples, salts and sugars. In certain embodiments, the reverse osmosis membrane can be a dialysis membrane that allows salts to pass through but not other substances, such as, for example, ionic contaminants, bacteria, and endotoxin. In certain embodiments, the membranes can also be electrified to remove ions (i.e., electrodialysis). In certain embodiments, at ambient conditions of about 18° C. to about 22° C., electrodialysis uses at least about 1 kWh/1000 US gallon per 1000 ppm of salt removed. This energy requirement varies significantly with changes in temperature: higher temperatures need less energy.

In some embodiments, the biosurfactant is utilized after being extracted from a fermentation broth and, optionally, purified.

The biosurfactant according to the subject invention can be, for example, a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. In preferred embodiments, the SLP is a linear SLP or a derivatized linear SLP.

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total filtration aid composition.

In another embodiment, a purified biosurfactant may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of liquid being treated.

In certain embodiments, the chemical surfactant in the reverse osmosis system is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total composition. In certain embodiments, the chemical surfactant comprises sodium laureth sulfate, sodium stearate, amine oxide, ethoxylation, cationic surfactant, alkyl polyglycoside, ammonium lauryl sulfate, ammonium, sulfonate, docusate sodium, or any combination thereof. In some embodiments, the conventional reverse osmosis component (e.g., chemical surfactant, antiscalant, biocides, preservatives, chlorine removers, membrane cleaners, and pH boosters) can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total composition.

In some embodiments, the antiscalant is at a concentration of about 1 ppm to about 20 ppm. In preferred embodiments, the concentration of the antiscalant is about 5 ppm to about 20 ppm.

In some embodiments, the preservative is at a concentration of about 0.25 tablespoons to about 3 tablespoons of the preservative per membrane. In preferred embodiments, 1 tablespoon of the preservative is added per membrane in the reverse osmosis system.

In certain embodiments, the membrane cleaner is applied to the membrane at a pressure of about 0.5 PSI to about 10 PSI per membrane element. In certain embodiments, the application of the cleaner can be stopped every 30 to 60 minutes to allow the membranes to absorb the cleaner for about 30 minutes to about 60 minutes.

The composition can further comprise other additives such as, for example, carriers, other microbe-based compositions, additional biosurfactants, enzymes, catalysts, solvents, salts, buffers, chelating agents, acids, emulsifying agents, lubricants, solubility controlling agents, preservatives, stabilizers, ultra-violet light resistant agents, viscosity modifiers, preservatives, tracking agents, and other microbes and other ingredients specific for an intended use.

In certain embodiments, chelating agents can be, but are not limited to, ethylenediaminetetraacetic acid (EDTA), nitrilotriacetic acid (NTA), a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na5P3010), trisodium phosphate (TSP), water, carbohydrates, organic acids with more than one coordination group (e.g., citric acid), lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na₄, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

### Methods of Reverse Osmosis

In certain embodiments, the subject invention provides a method for purifying an aqueous solution, preferably water, using a composition comprising biosurfactant in the reverse osmosis process.

In certain embodiments, the method comprises introducing an aqueous solution containing impurities and a composition comprising a biosurfactant to the high-pressure side of a reverse osmosis membrane and pressurizing the aqueous solution on the high-pressure side to produce liquid on the low-pressure side substantially free of the impurities. In certain embodiments, the impurities can be concentrated on the high-pressure side of the reverse osmosis membrane. In certain embodiments, a composition comprising a biosurfactant can be contacted to the reverse osmosis membrane before the aqueous solution is applied to the reverse osmosis membrane. In certain embodiments, the concentrated impurities can be removed from the high-pressure side of the reverse osmosis membrane.

The method of reverse osmosis comprises using a semi-permeable filter membrane to filter contaminants out of the water. Reverse osmosis can remove organisms, such as, for example, protozoa and bacteria. In certain embodiments, reverse osmosis can remove viruses. Reverse osmosis can also remove chemicals and chemical compounds, such as, for example, lead, chromium, copper, chloride, sodium, phosphorous, nitrate, potassium, magnesium, calcium, sulfate, radium, fluoride, and arsenic.

Reverse osmosis can have one stage or two different stages and one pass or two different passes. In a one stage reverse osmosis system, the contaminated water enters the system as one stream and exits the reverse osmosis system as either concentrate (i.e., water that does not pass through the membrane) or permeate water (i.e., water that does pass through the membrane). In a two-stage system the concentrate from the first stage becomes the feed water to the second stage. In certain embodiments, the permeate water is collected from the first stage and is combined with permeate water from the second stage. In certain embodiments, additional stages increase the recovery from the system.

In a reverse osmosis system, an array describes the physical arrangement of the pressure vessels in a 2-stage system. 2-stage systems are the most common reverse osmosis systems, but in some embodiments, more membranes can be added in order to increase the filtration. Pressure vessels contain reverse osmosis membranes, such as, at least 1, 2, 3 4, 5, 6, 7, 8, 9, 10, or more membranes. In certain embodiments, the concentrate water of each stage becomes the feed stream for the next successive stage.

In certain embodiments, the biosurfactant can be applied to the semi-permeable membrane. In some embodiments, the biosurfactant can be added to the contaminated liquid before the reverse osmosis process.

In some embodiments, reverse osmosis involves four steps of filtration: a sediment filter, pre-carbon block, reverse osmosis membrane, and a post carbon filter. In some embodiments, a sediment filter, pre-carbon block, and/or post carbon filter are optional steps of filtration. The sediment filter removes the largest particles. Sediment filters contain a housing, which is usually plastic, surrounding the filter medium, such as, for example, a paper, ceramic, polypropylene, acrylic fiber, glass fiber, polyester, spun cellulose, or rayon filter. The pre-carbon filter uses activated carbon to prevent substances larger than about 15 to about 220 microns from passing through the membrane and bonding with cations. The reverse osmosis membrane then removes molecules heavier than water (18.01528 g/mol), including, for example, sodium, lead, fluoride, or dissolved minerals. The post-carbon filter polishes the water, removing any microscopic particulate material.

In certain embodiments, the subject compositions can be applied directly to the reverse osmosis membrane and/or to the water in need of purification.

In certain embodiments, the hydrophobic tail of each surfactant surrounds an impurity and separates it from the water, inhibiting the impurity from passing through the reverse osmosis membrane by agglomerating impurities together.

In certain embodiments, the microbe-containing and/or biosurfactant-containing composition can enhance and/or increase the rate of purifying of the contaminated liquid using reverse osmosis. For example, in some embodiments, a sophorolipid will form a micelle that can contain or link the impurities, wherein the micelle is less than 500 μm, less than 100 μm, less than 10 μm, less than 1 μm, less than 100 nm, less than 50 nm, less than 25 nm, less than 15 nm or less than 10 nm in size. In certain embodiments, the impurities can be readily separated from the liquid after the micelle contains or links the impurities.

In certain embodiments, reverse osmosis filtration uses pressure, such as, for example, about 30 psi to about 800 psi, about 30 psi to about 250 psi, about 30 psi to about 100 psi, or about 60 psi, to force a liquid through the semi-permeable membrane. In certain embodiments, the amount of pressure is proportional to the size of the reverse osmosis tank that is holding the contaminated liquid. In some embodiments, low water pressure, such as, for example, below about 40 PSI, will result in reduced production and premature fouling of the membrane.

In certain embodiments, the reverse osmosis filtration occurs from about 20° C. to about 30° C.

Advantageously, in certain embodiments, the method according to the subject invention provides enhanced or increased efficiency at purifying a liquid, preferably water, using reverse osmosis with limited negative environmental impacts. In certain embodiments, the subject method can result in a decreased use of toxic methods during the purification of a liquid via reverse osmosis.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant, or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes can produce amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods to produce biomass (e.g., viable cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/1.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10¹, 1×10⁶, 1×10⁷, 1×10⁸, 1×10¹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 200 C, 15° C., 10° C., or 5° C. On the other hand, a biosurfactant composition can typically be stored at ambient temperatures.

I claim:

1. A method of reverse osmosis, the method comprising:
a) providing an aqueous liquid containing an impurity;
b) contacting a composition comprising biosurfactant to the aqueous liquid, a semi-permeable membrane, or a combination thereof; and
c) filtering the aqueous liquid through the semi-permeable membrane,
wherein the semi-permeable membrane has a high-pressure side and a low-pressure side during the filtering step; and
wherein a portion of the impurity remains on the high-pressure side of the semi-permeable membrane.

2. The method of claim 1, wherein the filtering comprises moving the aqueous liquid from the high-pressure side of the semi-permeable membrane to the low-pressure side of the semi-permeable membrane.

3. The method of claim 1, wherein the composition further comprises a chemical surfactant, antiscalant, biocide, preservative, chlorine remover, membrane cleaner, pH booster, or any combination thereof.

4. The method of claim 3, wherein the antiscalant is a polyacrylic acid, a carboxylic acid, a polymaleic acid, an organophosphate, a polyphosphate, a phosphonate, an anionic polymer, and any combination thereof.

5. The method of claim 3, wherein the biocide is sodium hypochlorite, chlorinated isocyanurate (trichloro-s-triazinetrione), chlorine dioxide, 1-Decanaminium, N-decyl-N, N-dimethyl chloride (DDAC QUAT), or any combination thereof.

6. The method of claim 3, wherein the chlorine remover is potassium metabisulfite, sodium metabisulfite, or any combination thereof.

7. The method of claim 1, wherein the biosurfactant is a glycolipid and/or a yeast culture comprising a glycolipid.

8. The method of claim 7, wherein the yeast culture is a Starmerella sp. and/or a Candida sp. yeast.

9. The method of claim 7, wherein the glycolipid is a sophorolipid, mannosylerythritol lipid, trehalose lipid, rhamnolipid, or any combination thereof.

10. The method of claim 9, wherein the sophorolipid is a linear sophorolipid or a lactonic sophorolipid.

11. A reverse osmosis composition comprising a biosurfactant and/or yeast culture comprising a biosurfactant and a traditional reverse osmosis component, wherein the traditional reverse osmosis component is selected from one or a combination of the following:
a) chemical surfactant;
b) antiscalant;
c) biocide;
d) preservative;
e) chlorine remover;
f) membrane cleaner; and
g) pH booster.

12. The composition of claim 11, wherein the biosurfactant is a glycolipid and/or a yeast culture comprising a glycolipid.

13. The composition of claim 12, wherein the yeast culture is Starmerella sp. And/or a Candida sp. Yeast.

14. The composition of claim 12, wherein the glycolipid is a sophorolipid, mannosylerythritol lipid, trehalose lipid, rhamnolipid, or any combination thereof.

15. The composition of claim 14, wherein the sophorolipid is a linear sophorolipid or a lactonic sophorolipid.

16. The composition of claim 11, wherein the antiscalant is a polyacrylic acid, a carboxylic acid, a polymaleic acid, an organophosphate, a polyphosphate, a phosphonate, an anionic polymer, and any combination thereof.

17. The composition of claim 11, wherein the biocide is sodium hypochlorite, chlorinated isocyanurate (trichloro-s-triazinetrione), chlorine dioxide, 1-Decanaminium, N-decyl-N, N-dimethyl chloride (DDAC QUAT), or any combination thereof.

18. The composition of claim 11, wherein the preservative is sodium benzoate, citric acid, potassium sorbate, phenoxyethanol, benzoic acid, sorbic acid, butylated hydroxytoluene, paraben, sodium nitrite, methylparaben, formaldehyde, butylated hydroxyanisole, a sulfite, propionic acid, benzyl acid, sugar, nisin, acetic acid, vinegar, propyl gallate, tert-Butylhydroquinone, a nitrite, lactic acid, or any combination thereof.

19. The composition of claim 11, wherein the chlorine remover is potassium metabisulfite, sodium metabisulfite, or any combination thereof.

20. The composition of claim 11, wherein the membrane cleaner is sodium hypochlorite, hydrochloric acid, nitric acid, sodium hydroxide, and any combination thereof.
